(19) United States
(12) Patent Application Publication
(10) Pub. No.: US 2024/0409370 A1
(43) Pub. Date: Dec. 12, 2024

(54) ELEVATOR SYSTEM CONFIGURED FOR ESTIMATING AN ELEVATOR CAR SPEED TO ADJUST CAR TOP VIRTUAL SAFETY NET ACTIONS

(71) Applicant: OTIS ELEVATOR COMPANY, Farmington, CT (US)

(72) Inventor: Randy Roberts, Hebron, CT (US)

(21) Appl. No.: 18/333,302

(22) Filed: Jun. 12, 2023

(51) Int. Cl. B66B 5/00; B66B 1/30; B66B 1/32; B66B 5/02

(52) U.S. Cl. CPC B66B 5/0056; B66B 1/30; B66B 1/32; B66B 5/0081; B66B 5/02; B66B 5/025

(57) ABSTRACT

An elevator system, having: a hoistway, a pit; a car; a sensor assembly, configured to capture and process images, configured to form a VSN around a first area that is exterior to the car, a safety chain configured to: monitor a change in positioning of a stationary object that is external to the car to determine a measured speed of the car, and upon detecting that an object has breached the VSN, the sensor assembly is configured to: select a first response protocol, from a set of response protocols that are correlated to different measured speeds of the car; and execute the first response protocol.

### BACKGROUND

The embodiments herein relate to elevator safety systems and more particularly to an elevator system configured for estimating an elevator car speed to adjust car top virtual safety net (VSN) actions.

Potential hazard conditions may exist in a hoistway because of a failure to take and maintain control of a car or counterweight. As a result, human sensing devices that open the elevator safety chain (e.g., cutting drive power and engaging the machine brake) may be installed in the hoistway and on top of the car in order to foolproof the system.

Elevator code specifies that mechanics should only ride on the car top when the car is traveling in inspection speeds and should stop the car when performing any operations that require them to lean over the handrails. Mechanics should avoid riding on the car top when the car is running in a normal mode. A system for preventing a mechanic from riding on top of an elevator car while the car is running in normal mode is desired.

### SUMMARY

Disclosed is an elevator system, including: a hoistway, an elevator pit and an elevator car; a sensor assembly configured to capture and process images, mounted within the elevator system, configured to form a virtual safety net (VSN) around at least a portion of a first area that is exterior to the elevator car; an elevator safety chain configured to: monitor a change in positioning of a stationary object that is external to the elevator car to determine a measured speed of the elevator car, and upon detecting that an object that is potentially human has breached the VSN, the sensor assembly is configured to: select a first response protocol, from a set of response protocols, that are correlated to different measured speeds of the elevator car; and execute the first response protocol.

In addition to one or more aspects of the system, or as an alternate, the sensor assembly is mounted to the elevator car, which includes a top and the first area is the top of the elevator car.

In addition to one or more aspects of the method, or as an alternate, the system includes a handrail system located at the top of the elevator car, wherein the VSN extends about one side of the handrail system and extends vertically above the handrail system by a predetermined distance.

In addition to one or more aspects of the system, or as an alternate, the sensor is located at a corner of the handrail system.

In addition to one or more aspects of the system, or as an alternate, the stationary object is a hoistway wall.

In addition to one or more aspects of the system, or as an alternate, the sensor is a motion, depth or range sensor.

In addition to one or more aspects of the system, or as an alternate, the sensor is one of a LIDAR, RADAR, or a camera.

In addition to one or more aspects of the system, or as an alternate, the sensor is a millimeter wave RADAR.

In addition to one or more aspects of the system, or as an alternate, the sensor is an RGBD camera.

In addition to one or more aspects of the system, or as an alternate, the set of response protocols are within a lookup table stored on non-transitory memory onboard the sensor assembly; and the set of response protocols includes one or more of: an emergency stop by opening the elevator safety chain, by the sensor assembly, to thereby cut power to the drive and engage a machine brake; sound an audio alarm; and slow the elevator car speed.

Further disclosed is a method of controlling an elevator system that includes a hoistway, a pit and an elevator car, the method including: monitoring, by a sensor assembly, including a sensor configured to capture and process images, within the elevator system, for a breach of a virtual safety net (VSN) by an object that is potentially human, the VSN being formed by the sensor; monitoring, by the sensor assembly, a change in positioning of a stationary object that is external to the elevator car to determine a measured speed of the elevator car; and upon detecting, by the sensor assembly, that the object has breached the VSN: selecting, by the sensor assembly, a first response protocol, from a set of response protocols, that are correlated to different measured speeds of the elevator car; and executing the first response protocol.

In addition to one or more aspects of the method, or as an alternate, the sensor assembly is mounted to the elevator car, which includes a top and the first area is the top of the elevator car.

In addition to one or more aspects of the method, or as an alternate, the method includes activating a sensor on a handrail system located at the top of the elevator car, to thereby provide the VSN about one side of the handrail system, wherein the VSN extends vertically above the handrail system by a predetermined distance.

In addition to one or more aspects of the method, or as an alternate, the sensor is located at a corner of the handrail system.

In addition to one or more aspects of the method, or as an alternate, the stationary object is a hoistway wall.

In addition to one or more aspects of the method, or as an alternate, the sensor is a motion, depth or range sensor.

In addition to one or more aspects of the method, or as an alternate, the sensor is one of a LIDAR, RADAR, or a camera.

In addition to one or more aspects of the method, or as an alternate, the sensor is a millimeter wave RADAR.

In addition to one or more aspects of the method, or as an alternate, the sensor is an RGBD camera.

In addition to one or more aspects of the method, or as an alternate, the set of response protocols are within a lookup table stored on non-transitory memory onboard the sensor assembly; and the method includes: selecting, by the sensor assembly, from the set of response protocols one or more of: an emergency stop by opening the elevator safety chain, by the sensor assembly, to thereby cut power to an elevator drive an engage a machine brake; sounding an audio alarm; and slowing the elevator car speed.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 shows additional aspects of the elevator system, configured with a plurality of motion sensors for detecting an object is on top of the elevator car;

FIG. 3 shows one of the sensors providing a virtual sensing plane extending to a hoistway wall;

FIG. 4 shows a graph of data representing objects on the hoistway wall from information captured by the sensor and processed by an elevator car controller at a first time;

FIG. 5 shows a graph of data representing objects on the hoistway wall from information captured by the sensor and processed by an elevator car controller at a second time that is later than the first time;

FIG. 6 is a flowchart for a process executed by the elevator system for detecting an object on top of the elevator car and responsively controlling the elevator car based on the detected elevator car speed; and

FIG. 7 is a flowchart generally showing the process executed by the elevator system for detecting an object on top of the elevator car and responsively controlling the elevator car based on the detected elevator car speed.

### DETAILED DESCRIPTION

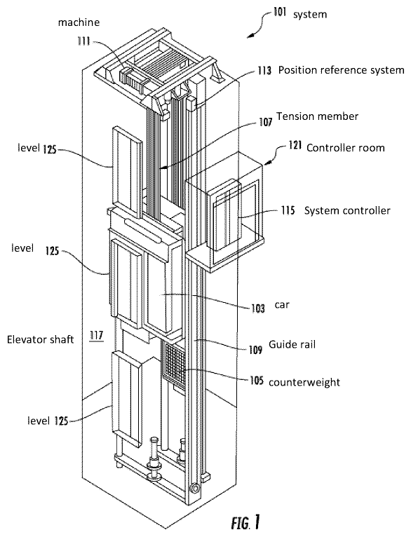

FIG. 1 is a perspective view of an elevator system 101 including an elevator car 103, a counterweight 105, a tension member 107, a guide rail 109, a machine 111 (alternatively referred to as a drive), a position reference system 113, and a system controller 115, which may be utilized to control normal elevator car operations and active safety functions. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The system controller 115 is located, as shown, in a controller room 121 of the elevator shaft 117 and is configured to control the operation of the elevator system 101, and particularly the elevator car 103. It is to be appreciated that the controller 115 need not be in the controller room 121 by may be in the hoistway or other location in the elevator system. For example, the system controller 115 may provide drive signals to the machine 111 to control the acceleration, deceleration, leveling, stopping, etc. of the elevator car 103. The system controller 115 may also be configured to receive position signals from the position reference system 113 or any other desired position reference device. When moving up or down within the elevator shaft 117 along guide rail 109, the elevator car 103 may stop at one or more landings 125 as controlled by the system controller 115. Although shown in a controller room 121, those of skill in the art will appreciate that the system controller 115 can be located and/or configured in other locations or positions within the elevator system 101. In one embodiment, the system controller 115 may be located remotely or in a distributed computing network (e.g., cloud computing architecture). The system controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

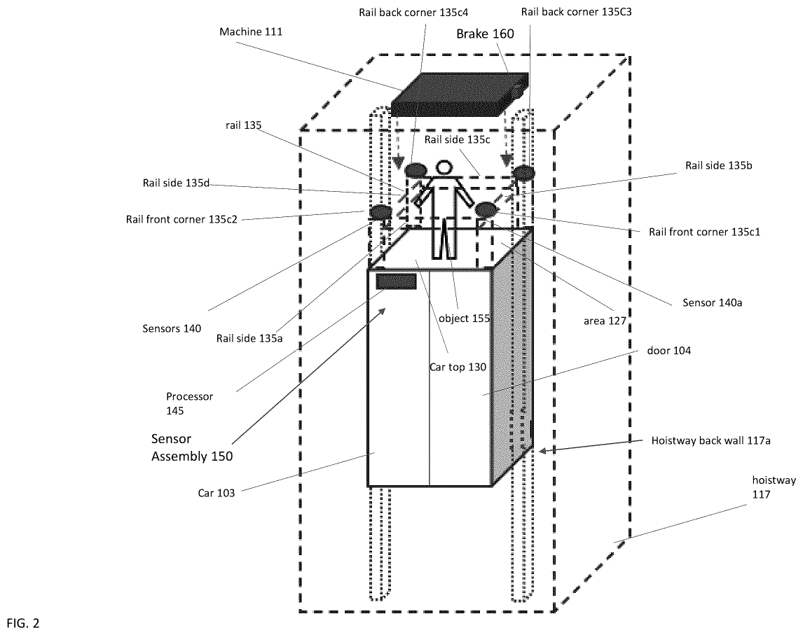

As shown in FIG. 2, the elevator car 10, in the hoistway 117, including a rear wall 117a, has a sensor assembly 150, which may include one or more sensors 140 and may further include or communicate with a processor 145, and which may capture and process images 142. The sensor assembly 150 has memory and communication circuitry so that it communicates, e.g., with the system controller 115 via an intelligent safety control system. The sensor assembly 150 may include link to a controllable relay that can be opened to open the safety chain. The connection to the safety chain could be via an electrical relay or via an intelligent safety control system via a communicated message to the elevator safety system, including the system controller 115.

A car top 130 may be equipped with a handrail system 135, extending between front rail corners 135c1-c2, e.g., above the door 104, and rear corners 135c3-c4 and having four handrail sides 135a-135d.

The car top 130 may be equipped with the sensors 140, including a first sensor 140a, disposed on the handrail system 135, at one or more of the corners 135c1-c4. It is to be appreciated that other mounting configurations in the elevator system are within the scope of the disclosure. The sensors 140, which may be range or depth sensors, may be motion sensors. The sensors 140 may be LIDAR, RADAR such as millimeter wave RADAR, or a camera such as an RGBD camera.

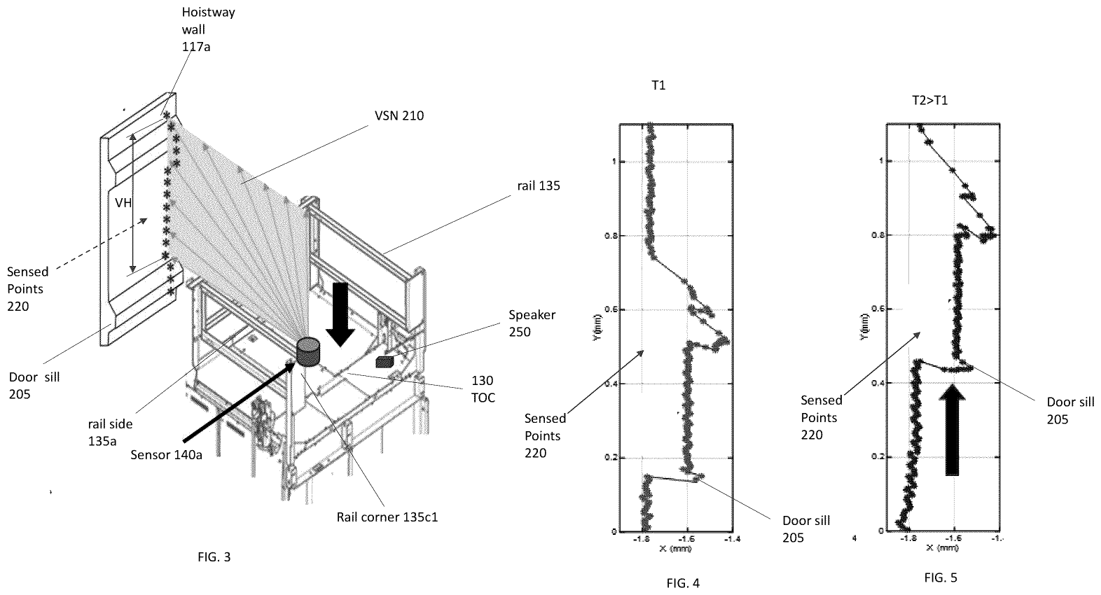

In one embodiment, the sensor assembly 150 is configured to sense when an object 155 that is of concern, because of its size and movement that are indicative of it being potentially human, i.e., a mechanic, is above the elevator car 103 and extending beyond the elevator car, e.g., into the hoistway 117, and the elevator safety chain is opened. This results in cutting drive power from the machine 111 and engaging the machine brake 160. The sensor assembly 150 may alternatively be mounted elsewhere on the elevator car, such as the bottom, or the elevator system such as within the hoistway, the pit, including the pit ladder. Turning to FIG. 3, the embodiments provide for monitoring a top of the car (TOC), with the sensor 140a that may be a LIDAR sensor. The sensor 140a is mounted to one of the front handrail corners 135c1. The sensor 140a is configured to project a two dimensional (2D) virtual sensing plane or virtual fence section of a virtual safety net (VSN)) 210, across one rail side 135a that is perpendicular to the hoistway wall 117a. The VSN 210 extends vertically above the top of the handrail system 135 car by a predetermined vertical height (or distance) VH, which may be one meter, to define the virtual planar fence.

The sensor assembly 150 senses any part of the mechanic 155, such as an arm, breaching the VSN 210. The elevator safety chain would be opened upon sensing the mechanic breaching the VSN 210, e.g., cutting power to the drive 111 and engaging the machine brake 160. This set of response protocols may be stored in the sensor assembly 150, within a lookup table, on non-transitory memory onboard the sensor assembly 150, as one example.

The sensor assembly 150 can also detect stationary objects outside of the handrail area, such as the hoistway wall 117a and generate datapoints 220 representing a vertical profile of the 117a. For example, the sensor assembly 150 may generate datapoints 220 representing the door sill 205 when the elevator car 103 is moving past an elevator lobby.

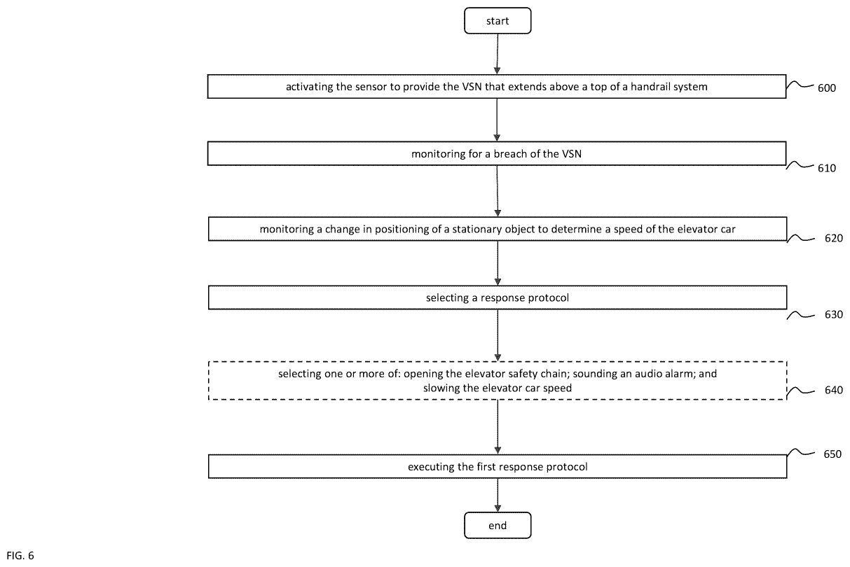

More specifically, as shown in FIGS. 4 and 5, periodically, when the car 103 is moving, the sensor assembly 150 generates datapoints 220 of the hoistway wall 117a, which is utilized to determine a change in location over time relative to the elevator car 103. The change in location over time is utilized to determine the elevator car speed and direction. For example, the image in FIG. 4 represents datapoints 220 generated by the sensor assembly 150 at 4.5 seconds from a set point, which may be when the elevator car 103 starts moving, and the image in FIG. 5 represents the datapoints 220 generated by the sensor assembly 150 at 4.7 seconds, i.e., 200 milliseconds later. Each set of datapoints 220 captures the position of the door sill 205 at a particular floor relative to the elevator car 103. As the sill 205 is higher relative to the elevator car in FIG. 5 than in FIG. 4, the determination is made that the elevator car 103 is moving downward. The magnitude of the change in position during the duration between measurements in FIGS. 4 and 5 is indicative of the speed at which the elevator car 103 is moving downward. The velocity of the elevator car 103 can be estimated by characterizing the wall features and how they vary scan-by-scan, which provides a time stamp.

In addition to the sensed range values, the sensor could also record the reflected intensity of the signal as a function of the scanned angle. This signal could also be used as part of the data processing to create a description of the wall at any instance of time. Where walls are flat, the intensity can identify wall features, including textures for example.

Depending on the speed and whether a mechanic 155 is breaching the VSN 210, the sensor assembly 150 may make a determination on how to control the elevator car 103. For example, an emergency stop (e-stop) may be executed by opening the safety chain by the sensor assembly 150, sound an audio alarm via a speaker 250 on the top 130 of the elevator car 103, or institute a controlled stop or a slowdown of the elevator car 103.

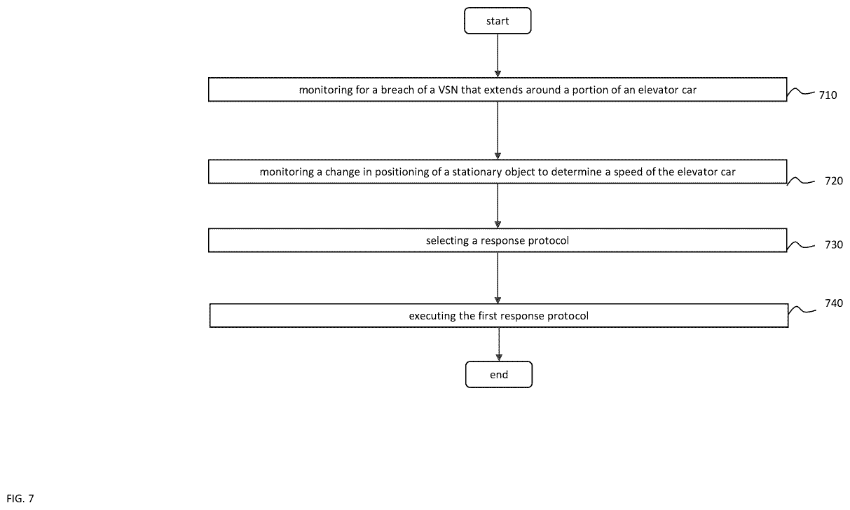

FIG. 6 is a flowchart for a process executed by the elevator system 101 for detecting the object 155 on the top 130 of the elevator car 103 and responsively controlling the elevator car 103 based on the detected elevator car 103 speed.

As shown in block 600, the method includes activating the sensor 140a at the corner 135c1 of the handrail system 135 located at the top 130 of the elevator car 103. This provides the VSN 210 about one side 135a of the handrail system 135. The VSN 210 extends vertically above the handrail system 135 by a predetermined distance.

As shown in block 610, the method includes monitoring, by the sensor assembly 150 of the elevator car 103, for a breach of the VSN 210 by an object 155. As shown in block 620, the method includes monitoring, by the sensor assembly 150, a change in positioning of a stationary object 205 that is external to the elevator car 103 to determine a measured speed of the elevator car 103. As shown in block 630, the method includes selecting, by the sensor assembly 150, a first response protocol, from a set of response protocols, that are correlated to different measured speeds of the elevator car 103, the first response including controlling one or more of drive 111, the machine brake 160 and the alarm speaker 250 to sound an alarm, or provide a visual alert such as utilizing lights. As shown in block 640, the method includes selecting, by the sensor assembly 150, from the set of response protocols stored in a look-up table on a non-transitory memory onboard the sensor assembly 150. One of the responses may be an emergency stop by opening the elevator safety chain to thereby cut power to the elevator drive 111 an engage the machine brake 160. One of the responses may be controlling the speaker 250 to sound an audio alarm. One of the responses may be slowing the elevator car 103 speed. As shown in block 650, the method includes executing the first response protocol.

FIG. 7 is a flowchart generally showing the process executed by the elevator system 101 for detecting the object 155 on the top 130 of the elevator car 103 and responsively controlling the elevator car 103 based on the detected elevator car 103 speed.

As shown in block 710, the method includes monitoring, by the sensor assembly 150 of the elevator car 103, for a breach of the VSN 210 by an object 155, the VSN 210 being formed by a sensor 140a mounted to the elevator car 103, around a portion of a first area 127 that is exterior to the elevator car 103. In one embodiment the first area 127 is a top 130 of the elevator car 103. The disclosed detection process can be applied to other areas of the elevator system 101, such as the pit area, ladder, etc.

As shown in block 720, the method includes monitoring, by the sensor assembly 150, a change in positioning of a stationary object 205 that is external to the elevator car 103 to determine a measured speed of the elevator car 103. As shown in block 730, the method includes selecting, by the sensor assembly 150, a first response protocol, from a set of response protocols, that are correlated to different measured speeds of the elevator car 103, the first response including controlling one or more of drive 111, the machine brake 160 and the alarm speaker 250 to sound an alarm. As shown in block 740, the method includes executing the first response protocol.

The embodiments provide a dual use of a single LIDAR sensor 140a to allow the system to provide both the safety net feature along at least one rail side 135a of the elevator car 103 and also a vertical speed sensing capability. These two functions enable the system 101 to select from a range of potential actions, such as e-stop, sound an audio alarm, or a trigger to the sensor assembly 150 to institute a controlled stop or a slowdown.

Sensor data identified herein may be obtained and processed separately, or simultaneously and stitched together, or a combination thereof, and may be processed in a raw or complied form. The sensor data may be processed on the sensor (e.g. via edge computing), by controllers identified or implicated herein, on a cloud service, or by a combination of one or more of these computing systems. The senor may communicate the data via wired or wireless transmission lines, applying one or more protocols as indicated below.

Wireless connections may apply protocols that include local area network (LAN, or WLAN for wireless LAN) protocols. LAN protocols include WiFi technology, based on the Section 802.11 standards from the Institute of Electrical and Electronics Engineers (IEEE). Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. LAN and WAN protocols may be generally considered TCP/IP protocols (transmission control protocol/Internet protocol), used to govern the connection of computer systems to the Internet. Wireless connections may also apply protocols that include private area network (PAN) protocols. PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. The Internet of things (IoT) describes the network of physical objects—“things”—that are embedded with sensors, software, and other technologies for the purpose of connecting and exchanging data with other devices and systems over the Internet. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). Other wireless platforms based on RFID technologies include Near-Field-Communication (NFC), which is a set of communication protocols for low-speed communications, e.g., to exchange date between electronic devices over a short distance. NFC standards are defined by the ISO/IEC (defined below), the NFC Forum and the GSMA (Global System for Mobile Communications) group. The above is not intended on limiting the scope of applicable wireless technologies.

Wired connections may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

When data is transmitted over a network between end processors as identified herein, the data may be transmitted in raw form or may be processed in whole or part at any one of the end processors or an intermediate processor, e.g., at a cloud service (e.g. where at least a portion of the transmission path is wireless) or other processor. The data may be parsed at any one of the processors, partially or completely processed or complied, and may then be stitched together or maintained as separate packets of information. Each processor or controller identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium.

The controller may further include, in addition to a processor and non-volatile memory, one or more input and/or output (I/O) device interface(s) that are communicatively coupled via an onboard (local) interface to communicate among other devices. The onboard interface may include, for example but not limited to, an onboard system bus, including a control bus (for inter-device communications), an address bus (for physical addressing) and a data bus (for transferring data). That is, the system bus may enable the electronic communications between the processor, memory and I/O connections. The I/O connections may also include wired connections and/or wireless connections identified herein. The onboard interface may have additional elements, which are omitted for simplicity, such as controllers, buffers (caches), drivers, repeaters, and receivers to enable electronic communications. The memory may execute programs, access data, or lookup charts, or a combination of each, in furtherance of its processing, all of which may be stored in advance or received during execution of its processes by other computing devices, e.g., via a cloud service or other network connection identified herein with other processors.

Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system, comprising:
a hoistway, an elevator pit and an elevator car;
a sensor assembly configured to capture and process images, mounted within the elevator system, configured to form a virtual safety net (VSN) around at least a portion of a first area that is exterior to the elevator car;
an elevator safety chain configured to:
monitor a change in positioning of a stationary object that is external to the elevator car to determine a measured speed of the elevator car, and
upon detecting that an object that is potentially human has breached the VSN, the sensor assembly is configured to:
select a first response protocol, from a set of response protocols, that are correlated to different measured speeds of the elevator car; and
execute the first response protocol.

2. The system of claim 1, wherein the sensor assembly is mounted to the elevator car, which includes a top and the first area is the top of the elevator car.

3. The system of claim 2, including:
a handrail system located at the top of the elevator car,
wherein the VSN extends about one side of the handrail system and extends vertically above the handrail system by a predetermined distance.

4. The system of claim 3, wherein the sensor is located at a corner of the handrail system.

5. The system of claim 1, wherein the stationary object is a hoistway wall.

6. The system of claim 1, wherein the sensor is a motion, depth or range sensor.

7. The system of claim 1, wherein the sensor is one of a LIDAR, RADAR, or a camera.

8. The system of claim 1, wherein the sensor is a millimeter wave RADAR.

9. The system of claim 1, wherein the sensor is an RGBD camera.

10. The system of claim 1, wherein:
the set of response protocols are within a lookup table stored on non-transitory memory onboard the sensor assembly; and
the set of response protocols includes one or more of: an emergency stop by opening the elevator safety chain, by the sensor assembly, to thereby cut power to the drive and engage a machine brake; sound an audio alarm; and slow the elevator car speed.

11. A method of controlling an elevator system that includes a hoistway, a pit and an elevator car, the method comprising:
monitoring, by a sensor assembly, including a sensor configured to capture and process images, within the elevator system, for a breach of a virtual safety net (VSN) by an object that is potentially human, the VSN being formed by the sensor;
monitoring, by the sensor assembly, a change in positioning of a stationary object that is external to the elevator car to determine a measured speed of the elevator car; and
upon detecting, by the sensor assembly, that the object has breached the VSN:
selecting, by the sensor assembly, a first response protocol, from a set of response protocols, that are correlated to different measured speeds of the elevator car; and
executing the first response protocol.

12. The method of claim 11, wherein the sensor assembly is mounted to the elevator car, which includes a top and the first area is the top of the elevator car.

13. The method of claim 12, including:
activating a sensor on a handrail system located at the top of the elevator car, to thereby provide the VSN about one side of the handrail system, wherein the VSN extends vertically above the handrail system by a predetermined distance.

14. The method of claim 13, wherein the sensor is located at a corner of the handrail system.

15. The method of claim 11, wherein the stationary object is a hoistway wall.

16. The method of claim 11, wherein the sensor is a motion, depth or range sensor.

17. The method of claim 11, wherein the sensor is one of a LIDAR, RADAR, or a camera.

18. The method of claim 11, wherein the sensor is a millimeter wave RADAR.

19. The method of claim 11, wherein the sensor is an RGBD camera.

20. The method of claim 11, wherein:
the set of response protocols are within a lookup table stored on non-transitory memory onboard the sensor assembly; and
the method includes:
selecting, by the sensor assembly, from the set of response protocols one or more of: an emergency stop by opening the elevator safety chain, by the sensor assembly, to thereby cut power to an elevator drive an engage a machine brake; sounding an audio alarm; and slowing the elevator car speed.
